(19) United States
(12) Patent Application Publication
(10) Pub. No.: US 2021/0229634 A1
(43) Pub. Date: Jul. 29, 2021

(54) CONTROL DEVICE, VEHICLE, CONTROL SYSTEM, PROGRAM, AND CONTROL METHOD

(71) Applicant: TOYOTA JIDOSHA KABUSHIKI KAISHA, Toyota-shi (JP)

(72) Inventor: Tatsunori KATOH, Nagoya-shi (JP)

(73) Assignee: TOYOTA JIDOSHA KABUSHIKI KAISHA, Toyota-shi (JP)

(21) Appl. No.: 16/948,921

(22) Filed: Oct. 6, 2020

(30) Foreign Application Priority Data
Jan. 29, 2020 (JP) 2020-012960

(51) Int. Cl. B60S 1/02; G01K 7/22; G01K 13/00

(52) U.S. Cl. CPC B60S 1/026; G01K 2201/02; G01K 13/00; G01K 7/22

(57) ABSTRACT

A control device causes an air conditioner of a vehicle to operate in response to a request signal which is transmitted from outside of the vehicle. The control device includes a control unit. When the request signal is received, the control unit is configured to estimate a degree of frost or a degree of fogging which has occurred on a window of the vehicle based on an inside air temperature, an outside air temperature, and an inside humidity of the vehicle and to set a time over which the air conditioner operates based on the degree of frost or the degree of fogging.

### CROSS-REFERENCE TO RELATED APPLICATION

This application claims priority to Japanese Patent Application No. 2020-012960 filed on Jan. 29, 2020, incorporated herein by reference in its entirety.

### BACKGROUND

### 1. Technical Field

The present disclosure relates to a control device, a vehicle, a control system, a program, and a control method.

### 2. Description of Related Art

In the related art, a technique of automatically controlling an air-conditioning device of a vehicle is known.

For example, Japanese Unexamined Patent Application Publication No. 2002-137630 (JP 2002-137630 A) discloses a technique of determining whether a defroster that removes frost or fogging is to operate based on an inside air temperature, an outside air temperature, and an inside humidity of a vehicle.

### SUMMARY

In the technique disclosed in JP 2002-137630 A, when it is determined that the defroster is to operate, the defroster is stopped after it has operated for a constant time. Since the time over which the defroster operates is constant, the defroster may continue to operate even after frost or fogging which has occurred on a window of the vehicle has been removed. There is room for improvement in the technique of controlling an air-conditioner having a defroster function in view of fuel efficiency, power consumption, influence on the environment, consumption of components, and the like.

The present disclosure is made to improve a technique of controlling an air conditioner of a vehicle.

According to the present disclosure, there is provided a control device that causes an air conditioner of a vehicle to operate in response to a request signal which is transmitted from outside of the vehicle, the control device including a control unit, wherein the control unit is configured to, when the request signal is received, estimate a degree of frost or a degree of fogging which has occurred on a window of the vehicle based on an inside air temperature, an outside air temperature, and an inside humidity of the vehicle and to set a time over which the air conditioner operates based on the degree of frost or the degree of fogging.

According to the present disclosure, there is provided a program causing a control device that causes an air conditioner of a vehicle to operate in response to a request signal which is transmitted from outside of the vehicle to perform an operation including:, when the request signal is received, estimating a degree of frost or a degree of fogging which has occurred on a window of the vehicle based on an inside air temperature, an outside air temperature, and an inside humidity of the vehicle; and setting a time over which the air conditioner operates based on the degree of frost or the degree of fogging.

According to the present disclosure, there is provided a control method in a control device that causes an air conditioner of a vehicle to operate in response to a request signal which is transmitted from outside of the vehicle, the control method including: when the request signal is received, estimating a degree of frost or a degree of fogging which has occurred on a window of the vehicle based on an inside air temperature, an outside air temperature, and an inside humidity of the vehicle; and setting a time over which the air conditioner operates based on the degree of frost or the degree of fogging.

According to the present disclosure, it is possible to improve a technique of controlling an air conditioner of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a control system according to an embodiment of the present disclosure;

FIG. 2 is a block diagram illustrating a configuration of a control device according to the embodiment of the present disclosure;

FIG. 3 is a block diagram illustrating a configuration of an information processing device according to the embodiment of the present disclosure;

FIG. 4 is a flowchart illustrating an operation flow of the control system according to the embodiment of the present disclosure; and

FIG. 5 is a flowchart illustrating an operation flow of the control system according to the embodiment of the present disclosure.

### DETAILED DESCRIPTION OF EMBODIMENTS

Hereinafter, an embodiment of the present disclosure will be described with reference to the accompanying drawings.

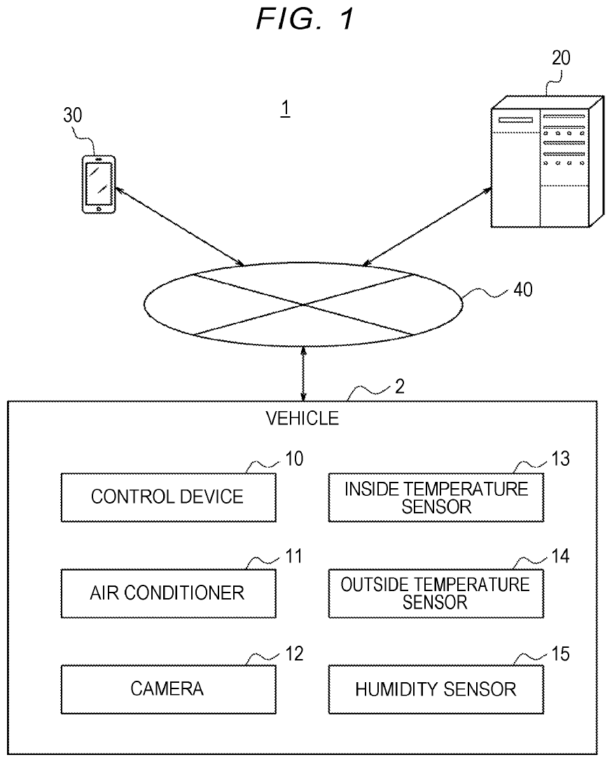

FIG. 1 is a block diagram illustrating a configuration of a control system 1 according to an embodiment of the present disclosure. The configuration and the outline of the control system 1 according to the embodiment of the present disclosure will be described below with reference to FIG. 1.

The control system 1 includes a vehicle 2, an information processing device 20, and a terminal device 30. The vehicle 2, the information processing device 20, and the terminal device 30 are communicatively connected to each other via a network 40. The network 40 may be a network including a mobile communication network and the Internet.

A single vehicle 2, a single information processing device 20, and a single terminal device 30 are illustrated in FIG. 1, but the numbers of vehicles 2, information processing devices 20, and terminal devices 30 may be two or greater.

The terminal device 30 transmits a request signal to the information processing device 20 in response to a user's operation. The request signal is a signal for requesting to start an engine of the vehicle 2 when the vehicle 2 is a gasoline vehicle or the like and is a signal for requesting to start an electric system of the vehicle 2 when the vehicle 2 is an electric vehicle (EV) or the like. When the request signal is received from the terminal device 30, the information processing device 20 transmits the request signal to the vehicle 2 which is associated with the terminal device 30. When the request signal is received, the vehicle 2 causes an air conditioner 11 to operate. When frost or fogging has occurred on a window of the vehicle 2, the frost or fogging can be removed by the operation of the air conditioner 11. The window in this embodiment is, for example, a front window, but is not limited thereto and may be a rear window or a side window.

The vehicle 2 may be an arbitrary type of vehicle such as a gasoline vehicle, a diesel vehicle, a hybrid vehicle (HV), a plug-in hybrid vehicle (PHV), an electric vehicle (EV), or a fuel cell vehicle (FCV). Driving of the vehicle 2 may be automated at an arbitrary level. The automation level may be, for example, any one of level 1 to level 5 in a classification of the Society of Automotive Engineers (SAE). The vehicle 2 may be a dedicated vehicle for a mobility as a service (MaaS). The configuration of the vehicle 2 will be described later.

The information processing device 20 can communicate with the vehicle 2 and the terminal device 30 via the network 40. The information processing device 20 receives a request signal from the terminal device 30. When a request signal is received from the terminal device 30, the information processing device 20 transmits the request signal to the vehicle 2 which is associated with the terminal device 30.

The information processing device 20 is, for example, a dedicated computer which is configured to serve as a server. The information processing device 20 may be a general-purpose personal computer (PC).

The terminal device 30 can communicate with the vehicle 2 and the information processing device 20 via the network 40. The terminal device 30 transmits a request signal to the information processing device 20 in response to a user's operation. The terminal device 30 is a device outside of the vehicle 2.

The terminal device 30 may be a dedicated device that can remotely start an engine or an electric system of the vehicle 2 or may be a general-purpose terminal device. When the terminal device 30 is a general-purpose terminal device, the terminal device 30 may be, for example, a smartphone or a tablet. When the terminal device 30 is a general-purpose terminal device, a dedicated program for remotely starting the engine or the electric system of the vehicle 2 may be installed in the terminal device 30.

As illustrated in FIG. 1, the vehicle 2 includes a control device 10, an air conditioner 11, a camera 12, an inside temperature sensor 13, an outside temperature sensor 14, and a humidity sensor 15. The control device 10, the air conditioner 11, the camera 12, the inside temperature sensor 13, the outside temperature sensor 14, and the humidity sensor 15 are communicatively connected to each other via an onboard network such as a controller area network (CAN) or a dedicated line.

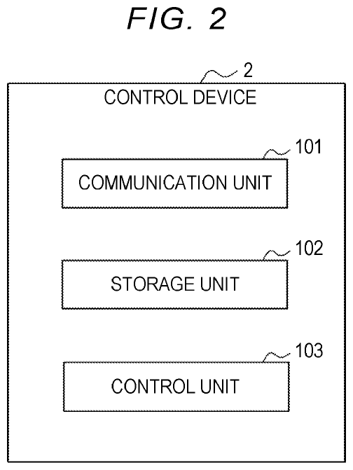

The control device 10 operates the air conditioner 11 when the engine or the electric system of the vehicle 2 is started in response to a request signal from the information processing device 20. The control device 10 may be, for example, an electronic control unit (ECU). As illustrated in FIG. 2, the control device 10 includes a communication unit 101, a storage unit 102, and a control unit 103.

The communication unit 101 includes a communication module that is connected to the network 40. For example, the communication unit 101 may include a communication module corresponding to a mobile communication standard such as Long Term Evolution (LTE), 4th Generation (4G), and 5th Generation (5G). In this embodiment, the control device 10 is connected to the network 40 via the communication unit 101. The communication unit 101 transmits and receives various types of information via the network 40. The communication unit 101 can communicate with the information processing device 20 and the terminal device 30 via the network 40.

The storage unit 102 is, for example, a semiconductor memory, a magnetic memory, or an optical memory, but is not limited thereto. The storage unit 102 may serve as, for example, a main storage device, an auxiliary storage device, or a cache storage device. The storage unit 102 stores arbitrary information which is used for operation of the control device 10. For example, the storage unit 102 may store a system program, an application program, and various types of information which are received by the communication unit 101. For example, information stored in the storage unit 102 may be updated with information which is received from the network 40 via the communication unit 101. A part of the storage unit 102 may be installed outside the control device 10. In this case, the part of the storage unit 102 which is installed outside may be connected to the control device 10 via an arbitrary interface.

The control unit 103 includes at least one processor, at least one dedicated circuit, or a combination thereof. The processor is a general-purpose processor such as a central processing unit (CPU) or a graphics processing unit (GPU) or a dedicated processor specialized in a specific process. The dedicated circuit is, for example, a field-programmable gate array (FPGA) or an application specific integrated circuit (ASIC). The control unit 103 controls constituent units of the control device 10 and performs processes associated with the operation of the control device 10.

Constituent units of the vehicle 2 will be described below referring back to FIG. 1.

The air conditioner 11 can blow hot wind or cold wind. The air conditioner 11 has a function of an air conditioner that adjusts an inside temperature of the vehicle 2 by blowing hot wind or cold wind. The air conditioner 11 has a defroster function. When the defroster function is performed, the air conditioner 11 can remove frost or fogging which has occurred on a window of the vehicle 2 by blowing hot wind to the window of the vehicle 2. When the vehicle 2 is a gasoline vehicle or the like, the air conditioner 11 may be driven with electric power which is supplied from an alternator with rotation of an engine of the vehicle 2 as a drive source.

The camera 12 can image the window of the vehicle 2. The camera 12 may include an imaging device that captures an image of visible light or may include an imaging device that captures an image of electromagnetic waves such as infrared light. The camera 12 transmits a captured image of the window to the control device 10. The camera 12 may be a camera that is incorporated in a drive recorder.

The inside temperature sensor 13 is a temperature sensor that is installed inside the vehicle 2. The inside temperature sensor 13 detects an inside air temperature of the vehicle 2. The inside temperature sensor 13 may be, for example, a temperature sensor using a thermistor. The inside temperature sensor 13 transmits information on the detected inside air temperature to the control device 10.

The outside temperature sensor 14 is a temperature sensor that is installed outside of the vehicle 2. The outside temperature sensor 14 may be installed, for example, in the vicinity of a front bumper of the vehicle 2. The outside temperature sensor 14 detects an outside air temperature of the vehicle 2. The outside temperature sensor 14 may be, for example, a temperature sensor using a thermistor. The outside temperature sensor 14 transmits information on the detected outside air temperature to the control device 10.

The humidity sensor 15 is a humidity sensor that is installed inside the vehicle 2. The humidity sensor 15 detects an inside humidity of the vehicle 2. The humidity sensor 15 transmits information on the detected inside humidity to the control device 10.

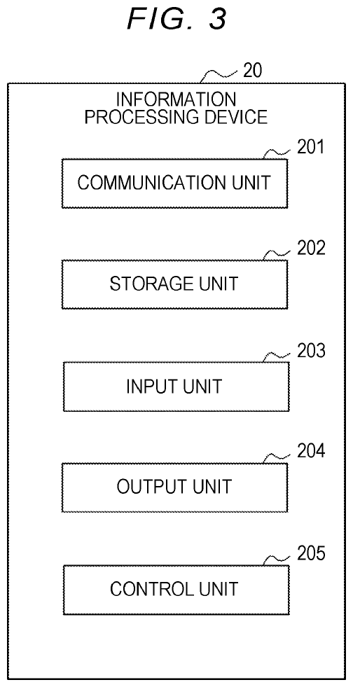

The configuration of the information processing device 20 according to the embodiment of the present disclosure will be described below with reference to FIG. 3.

The information processing device 20 includes a communication unit 201, a storage unit 202, an input unit 203, an output unit 204, and a control unit 205.

The communication unit 201 includes a communication module that is connected to the network 40. For example, the communication unit 201 may include a communication module corresponding to a local area network (LAN). In this embodiment, the information processing device 20 is connected to the network 40 via the communication unit 201. The communication unit 201 transmits and receives various types of information via the network 40. The communication unit 201 can communicate with the vehicle 2 and the terminal device 30 via the network 40.

The storage unit 202 is, for example, a semiconductor memory, a magnetic memory, or an optical memory, but is not limited thereto. The storage unit 202 may serve as, for example, a main storage device, an auxiliary storage device, or a cache storage device. The storage unit 202 stores arbitrary information which is used for operation of the information processing device 20. For example, the storage unit 202 may store a system program, an application program, and various types of information which are received by the communication unit 201. For example, information stored in the storage unit 202 may be updated with information which is received from the network 40 via the communication unit 201. A part of the storage unit 202 may be installed outside of the information processing device 20. In this case, the part of the storage unit 202 which is installed outside may be connected to the information processing device 20 via an arbitrary interface.

The input unit 203 includes one or more input interfaces that detect a user input and acquire input information based on a user's operation. For example, the input unit 203 may be a physical key, a capacitive key, a touch screen which is incorporated into a display of the output unit 204, or a microphone which receives a voice input, but is not limited thereto.

The output unit 204 includes one or more output interfaces that output information to notify a user thereof. For example, the output unit 204 may be a display that outputs information as an image or a speaker that outputs information in a voice, but is not limited thereto.

The control unit 205 includes at least one processor, at least one dedicated circuit, or a combination thereof. The processor is a general-purpose processor such as a CPU or a GPU or a dedicated processor specialized in a specific process. The dedicated circuit is, for example, an FPGA or an ASIC. The control unit 205 controls constituent units of the information processing device 20 and performs processes associated with the operation of the information processing device 20.

### Operation of Control System

The operation of the control system 1 illustrated in FIG. 1 will be described below with reference to FIGS. 1 to 3.

The terminal device 30 transmits a request signal to the information processing device 20 in response to a user's operation. For example, in the morning of a cold day, a user may transmit a request signal to the information processing device 20 by operating the terminal device 30 about 10 minutes to 20 minutes before a time at which the user will board the vehicle 2. In this way, by causing the air conditioner 11 to operate before the user boards the vehicle 2, the user can heat the inside of the vehicle 2 before the user boards the vehicle 2. By causing the air conditioner 11 to operate before the user boards the vehicle 2, the user can remove frost or fogging when the frost or fogging has occurred on the window of the vehicle 2.

The control unit 205 of the information processing device 20 acquires the request signal transmitted from the terminal device 30 via the communication unit 201. The request signal includes an identifier for identifying the corresponding vehicle 2.

When the request signal is received, the control unit 205 transmits the request signal to the vehicle 2 corresponding to the identifier included in the request signal via the communication unit 201.

When the request signal transmitted from the information processing device 20 is received, the vehicle 2 causes the air conditioner 11 of the vehicle 2 to operate.

When the air conditioner 11 of the vehicle 2 operates, the inside temperature sensor 13 detects the inside air temperature of the vehicle 2. The inside temperature sensor 13 transmits information of the detected inside air temperature to the control device 10.

When the air conditioner 11 of the vehicle 2 operates, the outside temperature sensor 14 detects the outside air temperature of the vehicle 2. The outside temperature sensor 14 transmits information of the detected outside air temperature to the control device 10.

When the air conditioner 11 of the vehicle 2 operates, the humidity sensor 15 detects the inside humidity of the vehicle 2. The humidity sensor 15 transmits information of the detected inside humidity to the control device 10.

The control unit 103 of the control device 10 acquires the information of the inside air temperature transmitted from the inside temperature sensor 13 via the communication unit 101. The control unit 103 acquires the information of the outside air temperature transmitted from the outside temperature sensor 14 via the communication unit 101. The control unit 103 acquires the information of the inside humidity transmitted from the humidity sensor 15 via the communication unit 101.

When the information of the inside air temperature, the information of the outside air temperature, and the information of the inside humidity are acquired, the control unit 103 estimates a degree of frost or a degree of fogging which has occurred on the window of the vehicle 2 based on the inside air temperature, the outside air temperature, and the inside humidity.

The degree of frost is an arbitrary index indicating what degree of frost has occurred on the window of the vehicle 2. The degree of frost may be expressed, for example, by a numerical value in a range of from 0 to 100. In this case, for example, when the degree of frost is “0,” it may mean that frost has not occurred. For example, when the degree of frost is “100,” it may mean that a maximum degree of frost which can be supposed has occurred.

The degree of fogging is an arbitrary index indicating what degree of fogging has occurred on the window of the vehicle 2. The degree of fogging may be expressed, for example, by a numerical value in a range of from 0 to 100. In this case, for example, when the degree of fogging is “0,” it may mean that fogging has not occurred. For example, when the degree of fogging is “100,” it may mean that a maximum degree of fogging which can be supposed has occurred.

An example of a method by which the control unit 103 estimates the degree of frost or the degree of fogging will be described below.

The control unit 103 estimates the temperature of the window of the vehicle 2 based on the inside air temperature and the outside air temperature. The storage unit 102 stores a table in which two parameters and the temperature of the window are correlated using the inside air temperature and the outside air temperature as the two parameters. In the following description, this table is also referred to a “first table.” The control unit 103 estimates the temperature of the window of the vehicle 2 based on the inside air temperature and the outside air temperature with reference to the first table stored in the storage unit 102. The first table is acquired, for example, by experiment or simulation, but is not limited thereto.

The control unit 103 determines whether frost has occurred on the window of the vehicle 2 based on the estimated temperature of the window and the inside humidity. For example, when the temperature of the window is equal to or lower than a predetermined temperature threshold value and the inside humidity is equal to or higher than a predetermined humidity threshold value, the control unit 103 determines that frost has occurred on the window of the vehicle 2.

When it is determined that frost has occurred on the window of the vehicle 2, the control unit 103 estimates a degree of frost which has occurred on the window of the vehicle 2. When it is determined that frost has not occurred on the window of the vehicle 2, the control unit 103 estimates a degree of fogging which has occurred on the window of the vehicle 2.

The storage unit 102 stores a table in which two parameters and the degree of frost are correlated using the temperature of the window and the inside humidity as the two parameters. In the following description, this table is also referred to a “second table.” At the time of estimation of the degree of frost, the control unit 103 estimates the degree of frost based on the temperature of the window and the inside humidity with reference to the second table stored in the storage unit 102. The second table is acquired, for example, by experiment or simulation, but is not limited thereto.

The storage unit 102 stores a table in which two parameters and the degree of fogging are correlated using the temperature of the window and the inside humidity as the two parameters. In the following description, this table is also referred to a “third table.” At the time of estimation of the degree of fogging, the control unit 103 estimates the degree of fogging based on the temperature of the window and the inside humidity with reference to the third table stored in the storage unit 102. The third table is acquired, for example, by experiment or simulation, but is not limited thereto.

The control unit 103 sets the first time based on the degree of frost when the degree of frost is estimated, and sets the first time based on the degree of fogging when the degree of fogging is estimated. When the first time is set, the control unit 103 causes the air conditioner 11 of the vehicle 2 to operate for a first time. Here, the “first time” is a time over which the air conditioner 11 is caused to operate for the purpose of removal of frost or fogging which has occurred on the window of the vehicle 2.

First, an example in which the control unit 103 sets the first time based on the degree of frost will be described below.

The storage unit 102 stores a table in which the degree of frost and the first time are correlated using the degree of frost as a parameter. In the following description, this table is also referred to a “fourth table.” The control unit 103 sets the first time which is a time required for defrosting based on the degree of frost with reference to the fourth table stored in the storage unit 102. The fourth table is acquired, for example, by experiment or simulation, but is not limited thereto.

At the time of setting the first time, the control unit 103 may set the first time in consideration of other factors in addition to the degree of frost. For example, the control unit 103 may set the first time in consideration of a capacity of the air conditioner 11 and a target value of a degree of visibility through the window in addition to the degree of frost. Here, the “capacity of the air conditioner 11” is an index indicating a heating capacity of the air conditioner 11 which is determined based on a temperature and an air volume of hot wind which is blown from the air conditioner 11. The “target value of the degree of visibility through the window” is a target value indicating to what extent the degree of visibility through the window is desired to be set by operating the air conditioner 11 to remove frost which has occurred on the window of the vehicle 2. The degree of visibility through the window may be, for example, an index indicating a ratio of an area in which frost or fogging has not occurred to the window by percentage. The degree of visibility through the window may be detected, for example, by causing the camera 12 to image the window and causing the control unit 103 to perform an image recognizing process on the image of the window.

An example in which the control unit 103 sets the first time based on the degree of frost, the capacity of the air conditioner 11, and the target value of the degree of visibility through the window will be described below.

The storage unit 102 stores a table in which two parameters and defrosting efficiency are correlated using the degree of frost and a capacity of the air conditioner 11 as the two parameters. In the following description, this table is also referred to a “fifth table.” The “defrost efficiency” is an index of an amount of frost which is removed per unit time. The control unit 103 calculates the defrosting efficiency based on the degree of frost and the capacity of the air conditioner 11 with reference to the fifth table stored in the storage unit 102. The fifth table is acquired, for example, by experiment or simulation, but is not limited thereto.

The storage unit 102 stores a table in which two parameters and the first time are correlated using the defrosting efficiency and a target value of a degree of visibility through the window as the two parameters. In the following description, this table is also referred to a “sixth table.” The control unit 103 sets the first time based on the defrosting efficiency and the target value of the degree of visibility through the window with reference to the sixth table stored in the storage unit 102. The sixth table is acquired, for example, by experiment or simulation, but is not limited thereto.

The case in which the control unit 103 sets the first time in consideration of the capacity of the air conditioner 11 and the target value of the degree of visibility through the window in addition to the degree of frost has been described above, but this is only an example. For example, factors which are considered by the control unit 103 in addition to the degree of frost may be one of the capacity of the air conditioner 11 and the target value of the degree of visibility through the window.

An example in which the control unit 103 sets the first time based on the degree of fogging will be described below.

The storage unit 102 stores a table in which the degree of fogging and the first time are correlated using the degree of fogging as a parameter. In the following description, this table is also referred to a “seventh table.” The control unit 103 sets the first time which is a time required for removing fogging based on the degree of fogging with reference to the seventh table stored in the storage unit 102. The seventh table may be a table which is prepared based on the inside air temperature of the vehicle 2 and a saturated water vapor amount in the vehicle 2. The seventh table is acquired, for example, by experiment or simulation, but is not limited thereto.

At the time of setting the first time, the control unit 103 may set the first time in consideration of other factors in addition to the degree of fogging. For example, the control unit 103 may set the first time in consideration of the capacity of the air conditioner 11 in addition to the degree of fogging.

An example in which the control unit 103 sets the first time based on the degree of fogging and the capacity of the air conditioner 11 will be described below.

The storage unit 102 stores a table in which two parameters and the first time are correlated using the degree of fogging and the capacity of the air conditioner 11 as the two parameters. In the following description, this table is also referred to an “eighth table.” The control unit 103 sets the first time based on the degree of fogging and the capacity of the air conditioner 11 with reference to the eighth table stored in the storage unit 102. The eighth table may be a table which is prepared based on the inside air temperature of the vehicle 2 and the saturated water vapor amount in the vehicle 2. The eighth table is acquired, for example, by experiment or simulation, but is not limited thereto.

The operation of the control device 10 when the first time has elapsed after the air conditioner 11 has started its operation will be described below.

The control unit 103 determines the degree of visibility through the window when the first time elapses after the air conditioner 11 has started its operation.

The control unit 103 compares the degree of visibility through the window with a predetermined threshold value and stops the operation of the air conditioner 11 when the degree of visibility through the window is equal to or greater than the predetermined threshold value. The predetermined threshold value is, for example, the above-mentioned target value, but is not limited thereto and may be arbitrarily determined. In this way, when frost or fogging has been removed to a desired extent, the control device 10 can prevent the air conditioner 11 from continuing to operate uselessly by stopping the operation of the air conditioner 11 at that time. Accordingly, the control device 10 can curb power consumption.

The control unit 103 compares the degree of visibility through the window with a predetermined threshold value and extends a time over which the air conditioner 11 operates when the degree of visibility through the window is less than the predetermined threshold value. The extended time may be a time which is set to a fixed value in advance. In the following description, the time which is set to the fixed value is also referred to as a “second time.” The second time may be, for example, about five minutes.

The control unit 103 compares an image of the window of the vehicle 2 which is captured by the camera 12 in a state in which neither frost nor fogging has occurred with an image of the window of the vehicle 2 which is captured by the camera 12 when the first time has elapsed after the air conditioner 11 has started its operation, and determines the degree of visibility through the window.

The control unit 103 may determine the degree of visibility through the window by comparing the images of the window of the vehicle 2 using other methods.

For example, the control unit 103 sets a difference between the degree of visibility (for example, 100%) of the image of the window which is captured by the camera 12 in a state in which neither frost nor fogging has occurred and the degree of visibility (for example, 20%) of the image of the window which is captured by the camera 12 when the air conditioner 11 has started its operation as a first difference (for example, 100−20=80 points). The control unit 103 sets a difference between the degree of visibility (for example, 20%) of the image of the window which is captured by the camera 12 when the air conditioner 11 has started its operation and the degree of visibility (for example, 80%) of the image of the window which is captured by the camera 12 when the first time has elapsed after the air conditioner 11 has started its operation as a second difference (for example, 80−20=60 points). Then, the control unit 103 may determine the degree of visibility through the window by comparing the first difference with the second difference. In this case, the control unit 103 determines that the degree of visibility through the window becomes greater as the ratio of the second difference to the first difference becomes greater.

At the time of imaging the window when the first time has elapsed after the air conditioner 11 has started its operation, the control unit 103 may image the window after a wiper of the vehicle 2 has been activated. Accordingly, the control unit 103 can decrease an influence of droplets and the like attached to the window after frost has been melted. At this time, the control unit 103 may acquire weather information from a server providing weather information via the network 40 and determine whether the wiper is to be activated based on the weather information. For example, when weather information indicating that it snows is acquired, the control unit 103 may not activate the wiper. Accordingly, the control unit 103 can prevent the wiper from being activated in a state in which snow is accumulated on the window and decrease a likelihood of failure of the wiper.

The control unit 103 may turn on a headlamp of the vehicle 2 when the camera 12 images the window of the vehicle 2. Accordingly, the camera 12 can image a situation of the window of the vehicle 2 even in an environment in which it is dark. At this time, the control unit 103 may turn on the headlamp of the vehicle 2 only when brightness around the vehicle 2 is equal to or less than a predetermined brightness threshold value. Accordingly, it is possible to prevent the headlamp from being uselessly turned on. The brightness around the vehicle 2 may be determined, for example, using an illuminance sensor.

Immediately after a user finishes driving of the vehicle 2 and stops the vehicle 2, neither frost nor fogging has occurred on the window of the vehicle 2 in general. Accordingly, for example, the control unit 103 may cause the camera 12 to capture an image of the window of the vehicle 2 immediately after the vehicle 2 has stopped and use the captured image as an image in a state in which neither frost nor fogging has occurred.

The control unit 103 may determine the degree of visibility through the window using a method other than the method based on an image of the window of the vehicle 2. For example, the control unit 103 may determine the degree of visibility through the window using a rain sensor that detects raindrops attached on the window. In this case, the control unit 103 may determine the degree of visibility through the window based on whether the rain sensor has detected raindrops on the window of the vehicle 2. The control unit 103 determines that the degree of visibility through the window is great when the rain sensor has not detected raindrops. For example, the control unit 103 may determine the degree of visibility through the window using a vibration sensor that detects vibration of the wiper. In this case, the control unit 103 may determine the degree of visibility based on the vibration which is detected by the vibration sensor when the wiper is activated. The control unit 103 determines that the degree of visibility through the window is great when vibration detected by the vibration sensor is small.

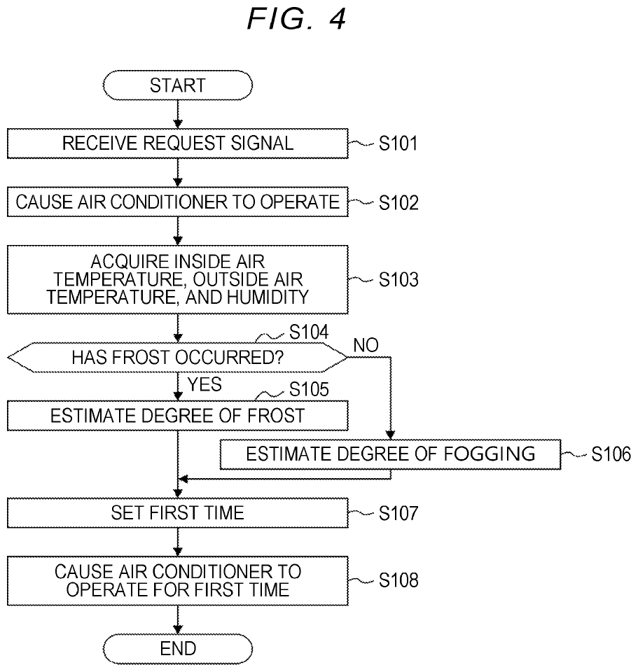

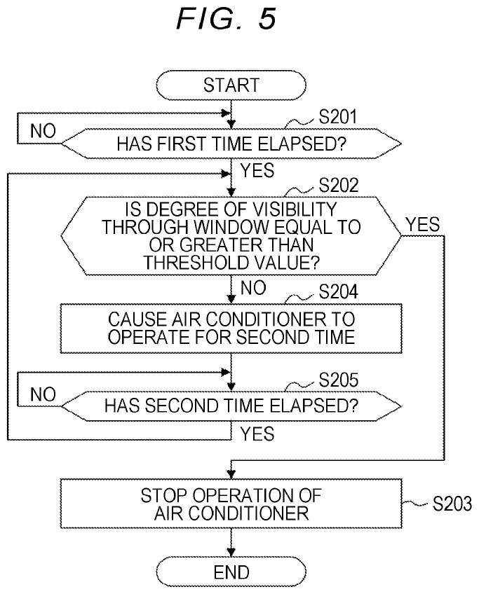

The operation of the control system 1 will be described below with reference to the flowcharts illustrated in FIGS. 4 and 5. FIG. 4 is a flowchart illustrating a process flow until the control device 10 starts the operation of the air conditioner 11. FIG. 5 is a flowchart illustrating a process flow after the control device 10 has started the operation of the air conditioner 11.

First, the operation of the control system 1 will be described with reference to the flowchart illustrated in FIG. 4.

In Step S101, the vehicle 2 receives a request signal transmitted from the terminal device 30 via the information processing device 20.

In Step S102, the vehicle 2 causes the air conditioner 11 of the vehicle 2 to operate.

In Step S103, the control device 10 acquires information of the inside air temperature of the vehicle 2 from the inside temperature sensor 13. The control device 10 acquires information of the outside air temperature of the vehicle 2 from the outside temperature sensor 14. The control device 10 acquires information of the inside humidity of the vehicle 2 from the humidity sensor 15.

In Step S104, the control device 10 estimates the temperature of the window of the vehicle 2 based on the inside air temperature and the outside air temperature, and determines whether frost has occurred on the window of the vehicle 2 based on the estimated temperature of the window and the inside humidity. When it is determined that frost has occurred, that is, when the determination result of Step S104 is YES, the control device 10 performs Step S105. When it is determined that frost has not occurred, that is, when the determination result of Step S104 is NO, the control device 10 performs Step S106.

In Step S105, the control device 10 estimates the degree of frost which has occurred on the window of the vehicle 2 based on the temperature of the window and the inside humidity.

In Step S106, the control device 10 estimates the degree of fogging which has occurred on the window of the vehicle 2 based on the temperature of the window and the inside humidity.

In Step S107, the control device 10 sets the first time based on the degree of frost when the degree of frost is estimated in Step S105. The control device 10 sets the first time based on the degree of fogging when the degree of fogging is estimated in Step S106.

In Step S108, the control device 10 causes the air conditioner 11 to operate for the first time.

The control device 10 may not perform the processes of Steps S103 to S108 after the air conditioner 11 of the vehicle 2 has been caused to operate in Step S102. For example, when the elapsed time after the vehicle 2 has been stopped is equal to or less than a predetermined time, the control device 10 may not perform the processes of Steps S103 to S108. The likelihood that frost or fogging has occurred on the window of the vehicle 2 immediately after the vehicle 2 has been stopped is low. In this case, by not performing the processes of Steps S103 to S108, the control device 10 can prevent the air conditioner 11 from operating uselessly when the likelihood that frost or fogging has occurred is low.

The operation of the control system 1 after the air conditioner 11 has operated will be described below with reference to the flowchart illustrated in FIG. 5.

In Step S201, the control device 10 determines whether the first time has elapsed after the air conditioner 11 has started its operation. When the first time has not elapsed, that is, when the determination result of Step S201 is NO, the control device 10 repeatedly performs the process of Step S201. When the first time has elapsed, that is, when the determination result of Step S201 is YES, the control device 10 performs Step S202.

In Step S202, the control device 10 determines whether the degree of visibility through the window is equal to or greater than a threshold value. When the degree of visibility through the window is equal to or greater than the threshold value, that is, when the determination result of Step S202 is YES, the control device 10 performs Step S203. When the degree of visibility through the window is less than the threshold value, that is, when the determination result of Step S202 is NO, the control device 10 performs Step S204.

In Step S203, the control device 10 stops the operation of the air conditioner 11.

In Step S204, the control device 10 causes the air conditioner 11 to operate additionally for the second time.

In Step S205, the control device 10 determines whether the second time has elapsed. When the second time has not elapsed, that is, when the determination result of Step S205 is NO, the control device 10 repeatedly performs the process of Step S205. When the second time has elapsed, that is, when the determination result of Step S205 is YES, the control device 10 performs Step S202 again.

When the determination result of Step S202 is NO one or more times, the control device 10 may update the values of one or more tables out of the first to eighth tables after the operation of the air conditioner 11 has been stopped in Step S203. Accordingly, the control device 10 can improve accuracy at the time of setting the first time in the next time.

As described above, in the control device 10 according to this embodiment, when a request signal transmitted from the outside of the vehicle 2 is received, the control unit 103 estimates the degree of frost or the degree of fogging which has occurred on the window of the vehicle 2 based on the inside air temperature, the outside air temperature, and the inside humidity of the vehicle 2. The control unit 103 sets the time over which the air conditioner 11 operates based on the estimated degree of frost or the estimated degree of fogging. In this way, in the control device 10 according to this embodiment, since the air conditioner 11 operates for the first time which is supposed to be required for removing frost or fogging which has occurred on the window, it is possible to prevent the air conditioner 11 from operating for a long time more than necessary. Accordingly, the control device 10 according to this embodiment can improve the technique of controlling the air conditioner 11 of the vehicle 2.

The present disclosure is not limited to the above embodiment. For example, two or more blocks illustrated in the block diagrams may be combined or a single block may be divided. Instead of sequentially performing the plurality of steps illustrated in the flowcharts in a time series, the steps may be performed in parallel or at different times according to the processing capacity of the device that performs the steps or according to necessity. In addition, the embodiment can be modified without departing from the gist of the present disclosure.

For example, some processes which are performed by the control device 10 according to the above embodiment may be performed by the information processing device 20.

For example, in the above embodiment, the control device 10 is mounted in the vehicle 2, but the control device 10 may be installed outside of the vehicle 2.

For example, a general-purpose electronic device such as a computer may serve as the control device 10 according to the above embodiment. Specifically, a program in which process details for realizing the functions of the control device 10 and the like according to the above embodiment are described can be stored in a memory of the electronic device and the program can be read and executed by a processor of the electronic device. Accordingly, the present disclosure can also be embodied as a program which can be executed by a processor.

For example, in the above embodiment, the vehicle 2 receives a request signal transmitted from the terminal device 30 via the information processing device 20, but the vehicle 2 may directly receive the request signal transmitted from the terminal device 30.

For example, in the above embodiment, the control unit 103 of the control device 10 calculates various types of values with reference to the first to eighth tables, but the type which is referred to by the control unit 103 is not limited to the table form. For example, the control unit 103 may calculate various types of values with reference a predetermined relational expression.

For example, in the above embodiment, the control unit 103 of the control device 10 estimates the degree of frost or the degree of fogging which has occurred on the window of the vehicle 2 based on the inside air temperature, the outside air temperature, and the inside humidity, but other factors may be considered at the time of estimating the degree of frost or the degree of fogging. For example, the control unit 103 may cause the camera 12 to image the window of the vehicle 2 and estimate the degree of frost or the degree of fogging which has occurred on the window of the vehicle 2 based on the inside air temperature, the outside air temperature, the inside humidity, and the image of the window.

What is claimed is:

1. A control device that causes an air conditioner of a vehicle to operate in response to a request signal which is transmitted from outside of the vehicle, the control device comprising a control unit,
wherein the control unit is configured to: when the request signal is received,
estimate a degree of frost or a degree of fogging which has occurred on a window of the vehicle based on an inside air temperature, an outside air temperature, and an inside humidity of the vehicle; and
set a time over which the air conditioner operates based on the degree of frost or the degree of fogging.

2. The control device according to claim 1, wherein the control unit is configured to:
estimate a temperature of the window based on the inside air temperature and the outside air temperature; and
estimate the degree of frost or the degree of fogging based on the temperature of the window and the humidity.

3. The control device according to claim 2, wherein the control unit is configured to:
determine whether frost has occurred on the window based on the temperature of the window and the humidity;
estimate the degree of frost when it is determined that frost has occurred and set the time over which the air conditioner operates based on the degree of frost and a target value of a degree of visibility through the window of the vehicle; and
estimate the degree of fogging when it is determined that frost has not occurred and set the time over which the air conditioner operates based on the degree of fogging and a saturated water vapor amount inside the vehicle.

4. The control device according to claim 1, wherein the control unit is configured to set the time over which the air conditioner operates additionally based on a capacity of the air conditioner.

5. The control device according to claim 1, wherein the control unit is configured to:
determine a degree of visibility through the window when the time over which the air conditioner operates elapses; and
extend the time over which the air conditioner operates when the degree of visibility through the window is less than a predetermined threshold value.

6. The control device according to claim 5, wherein the control unit is configured to extend the time over which the air conditioner operates to a preset fixed time when a degree of visibility through the window is less than the predetermined threshold value.

7. A vehicle in which the control device according to claim 1 is mounted.

8. A control system comprising:
the control device according to claim 1; and
an information processing device that transmits the request signal to the control device when the request signal is received from a terminal device.

9. A program causing a control device that causes an air conditioner of a vehicle to operate in response to a request signal which is transmitted from outside of the vehicle to perform an operation including: when the request signal is received,
estimating a degree of frost or a degree of fogging which has occurred on a window of the vehicle based on an inside air temperature, an outside air temperature, and an inside humidity of the vehicle; and
setting a time over which the air conditioner operates based on the degree of frost or the degree of fogging.

10. The program according to claim 9, wherein the estimating of the degree of frost or the degree of fogging includes:
estimating a temperature of the window based on the inside air temperature and the outside air temperature; and
estimating the degree of frost or the degree of fogging based on the temperature of the window and the humidity.

11. The program according to claim 10, wherein the estimating of the degree of frost or the degree of fogging includes:
determining whether frost has occurred on the window based on the temperature of the window and the humidity;
estimating the degree of frost when it is determined that frost has occurred and setting the time over which the air conditioner operates based on the degree of frost and a target value of a degree of visibility through the window of the vehicle; and
estimating the degree of fogging when it is determined that frost has not occurred and setting the time over which the air conditioner operates based on the degree of fogging and a saturated water vapor amount inside the vehicle.

12. The program according to claim 9, wherein the setting of the time over which the air conditioner operates includes setting the time over which the air conditioner operates additionally based on a capacity of the air conditioner.

13. The program according to claim 9, wherein the control device is caused to perform the operation further including:
determining a degree of visibility through the window when the time over which the air conditioner operates elapses; and
extending the time over which the air conditioner operates when the degree of visibility through the window is less than a predetermined threshold value.

14. The program according to claim 13, wherein the extending of the time over which the air conditioner operates further includes extending the time over which the air conditioner operates to a preset fixed time.

15. A control method in a control device that causes an air conditioner of a vehicle to operate in response to a request signal which is transmitted from outside of the vehicle, the control method comprising: when the request signal is received,
estimating a degree of frost or a degree of fogging which has occurred on a window of the vehicle based on an inside air temperature, an outside air temperature, and an inside humidity of the vehicle; and
setting a time over which the air conditioner operates based on the degree of frost or the degree of fogging.

16. The control method according to claim 15, wherein the estimating of the degree of frost or the degree of fogging includes:
estimating a temperature of the window based on the inside air temperature and the outside air temperature; and
estimating the degree of frost or the degree of fogging based on the temperature of the window and the humidity.

17. The control method according to claim 16, wherein the estimating of the degree of frost or the degree of fogging includes:
determining whether frost has occurred on the window based on the temperature of the window and the humidity;
estimating the degree of frost when it is determined that frost has occurred and setting the time over which the air conditioner operates based on the degree of frost and a target value of a degree of visibility through the window of the vehicle; and
estimating the degree of fogging when it is determined that frost has not occurred and setting the time over which the air conditioner operates based on the degree of fogging and a saturated water vapor amount inside the vehicle.

18. The control method according to claim 15, wherein the setting of the time over which the air conditioner operates includes setting the time over which the air conditioner operates additionally based on a capacity of the air conditioner.

19. The control method according to claim 15, further comprising:
determining a degree of visibility through the window when the time over which the air conditioner operates elapses; and
extending the time over which the air conditioner operates when the degree of visibility through the window is less than a predetermined threshold value.

20. The control method according to claim 19, wherein the extending of the time over which the air conditioner operates further includes extending the time over which the air conditioner operates to a preset fixed time.
